(19) United States
(12) Patent Application Publication
(10) Pub. No.: US 2011/0287222 A1
(43) Pub. Date: Nov. 24, 2011

(54) Group 3B nitride crystal

(75) Inventors: Takayuki Hirao, Nagoya-City (JP); Makoto Iwai, Kasugai-City (JP); Katsuhiro Imai, Nagoya-City (JP)

(73) Assignee: NGK Insulators, Ltd., Nagoya-City (JP)

(21) Appl. No.: 13/136,056

(22) Filed: Jul. 21, 2011

Related U.S. Application Data
(63) Continuation of application No. PCT/JP2009/071233, filed on Dec. 21, 2009.

(30) Foreign Application Priority Data
Jan. 23, 2009 (JP) 2009-012963

(51) Int. Cl. C01B 21/06; B32B 3/00

(52) U.S. Cl. 428/141; 423/409

(57) ABSTRACT

A sapphire substrate on a surface of which a thin film of gallium nitride is formed is prepared as a seed-crystal substrate and placed in a growth vessel. Gallium and sodium metals are weighed to achieve a molar ratio of 25 to 32:68 to 75 and added into the vessel. The vessel is put into a reaction vessel. An inlet pipe is connected to the reaction vessel. Nitrogen gas is introduced from a nitrogen tank through a pressure controller to fill the reaction vessel. While the internal pressure of the reaction vessel is controlled to be a predetermined nitrogen gas pressure and target temperatures are set such that the temperature of a lower heater is higher than the temperature of an upper heater, a gallium nitride crystal is grown. As a result, a group 13 nitride crystal having a large grain size and a low dislocation density is provided.

### FIELD OF THE INVENTION

The present invention relates to a crystal of a group 13 nitride such as gallium nitride.

### BACKGROUND OF THE INVENTION

In recent years, production of semiconductor devices such as blue LEDs, white LEDs, and violet semiconductor lasers by using group 13 nitrides such as gallium nitride and application of such semiconductor devices to various electronic apparatuses have been actively studied. Existing gallium nitride semiconductor devices are mainly produced by vapor-phase methods: specifically, by heteroepitaxial growth of a gallium nitride thin film on a sapphire substrate or a silicon carbide substrate by a metal-organic vapor phase epitaxy method (MOVPE) or the like. In this case, since such a substrate and the gallium nitride thin film are considerably different from each other in terms of thermal expansion coefficient and lattice constant, dislocations (one type of lattice defects in crystals) are generated at a high density in the gallium nitride. Accordingly, it is difficult to provide gallium nitride of high quality having a low dislocation density by vapor-phase methods. Other than vapor-phase methods, liquid-phase methods have also been developed. A flux method is one of such liquid-phase methods and, in the case of gallium nitride, allows a decrease in the temperature required for gallium nitride crystal growth to about 800° C. and a decrease in the pressure required for gallium nitride crystal growth to several megapascals to several hundred megapascals by using sodium metal as a flux. Specifically, nitrogen gas dissolves in a melt mixture of sodium metal and gallium metal and the melt mixture is supersaturated with gallium nitride and a crystal of gallium nitride grows. Compared with vapor-phase methods, dislocations are less likely to be generated in such a liquid-phase method and hence gallium nitride of high quality having a low dislocation density can be obtained.

Studies on such flux methods have also been actively performed. For example, Patent Document 1 discloses a method for producing a group 13 nitride crystal in which it is intended to increase the crystal growth rate and enhance the crystallinity and uniformity of the semiconductor crystal. Specifically, Patent Document 1 discloses a method for growing a gallium nitride crystal on a seed-crystal substrate in which the seed-crystal substrate is made to obliquely lean or stand up straight in a melt mixture of sodium metal and gallium metal. According to this method, since the melt mixture flows along a crystal growth surface due to heat convection, the melt mixture is sufficiently and uniformly fed to regions in the crystal growth surface.

### PRIOR ART DOCUMENT

### Patent Document

[Patent Document 1] Japanese Unexamined Patent Application Publication No. 2008-290929 (paragraph [0009], for example)

### SUMMARY OF INVENTION

The production method of Patent Document 1 provides a gallium nitride crystal having a large grain size (area surrounded by grain boundaries); however, there are cases where the crystal does not have an area with a low dislocation density, for example, an area with an etch pit density (EPD) on the order of 10⁴/cm² or less. When a gallium nitride crystal having a high dislocation density is used for, for example, a power control device to which a high voltage is applied, since the gallium nitride crystal often has through-holes extending in the thickness direction of the crystal and a leakage current may flow through the holes, a high voltage cannot be applied, which is problematic. Even when a gallium nitride crystal having a low dislocation density is present, a small grain size may result in a leakage current flowing through grain boundaries and hence a high voltage cannot also be applied, which is problematic.

A main object of the present invention is to provide a group 13 nitride crystal having a large grain size and a low dislocation density.

The inventors of the present invention have thoroughly studied the direction of flow of a melt mixture in a growth vessel and the concentration of gallium metal in the melt mixture. As a result, the inventors have found that a group 13 nitride crystal having a large grain size and a low dislocation density can be provided. Thus, the inventors have accomplished the present invention.

A group 13 nitride crystal according to the present invention has a feature of having a grain size in which a circle having a diameter of 1 mm can be contained wherein an etch pit density (EPD) within the circle is on the order of 10⁴/cm² or less (preferably, on the order of 10¹/cm² or less or no etch pit is observed).

Even when a high voltage is applied to a group 13 nitride crystal according to the present invention in the thickness direction, since the grain size is large, a leakage current does not flow through grain boundaries; and, since the dislocation density is low, through-holes extending in the thickness direction of the crystal are scarcely present and a leakage current does not flow through the holes. Accordingly, the crystal can be applied to devices required to be under application of a high voltage, such as power control devices used for inverters for hybrid vehicles.

Examples of the group 13 nitride include boron nitride (BN), aluminum nitride (AlN), gallium nitride (GaN), indium nitride (InN), and thallium nitride (TlN). Of these, gallium nitride is preferred.

When a group 13 nitride crystal according to the present invention is a gallium nitride crystal, the crystal emits pale blue fluorescence by irradiation with light having a wavelength of 330 to 385 nm. Such gallium nitride crystals are produced by flux methods. In general, gallium nitride crystals produced by flux methods emit blue fluorescence by irradiation with light having a wavelength of 330 to 385 nm. In contrast, gallium nitride crystals produced by vapor-phase methods emit yellow fluorescence by irradiation with such light. Accordingly, a crystal grown by a flux method and a crystal grown by a vapor-phase method can be distinguished from each other with respect to the color of fluorescence emitted from the crystal by irradiation with light having a wavelength of 330 to 385 nm.

### BRIEF DESCRIPTION OF DRAWINGS

The patent or application file contains at least one drawing executed in color. Copies of this patent or patent application with color drawing(s) will be provided by the Office upon request and payment of the necessary fee.

### BRIEF DESCRIPTION OF THE DRAWINGS

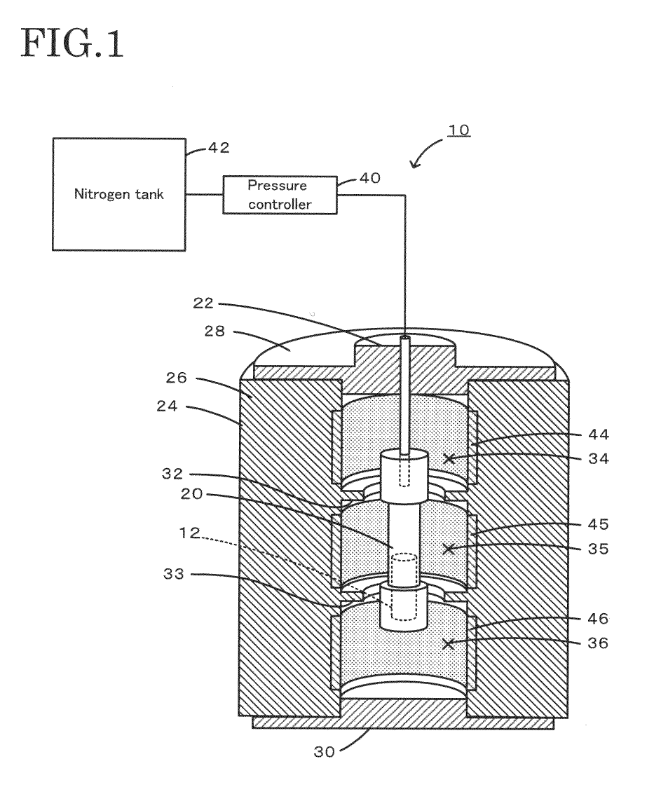

FIG. 1 is an explanatory view illustrating the entire configuration of a crystal substrate production apparatus 10.

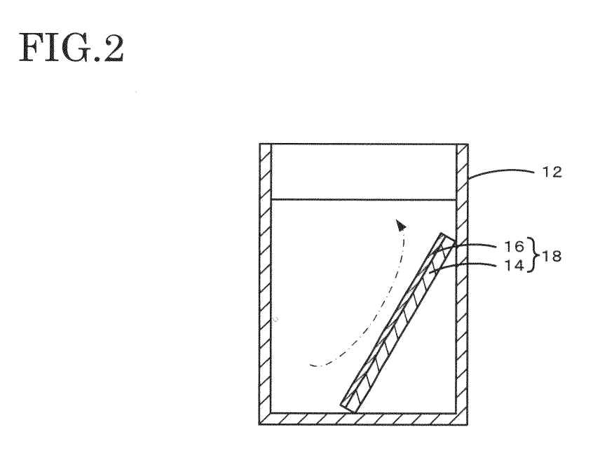

FIG. 2 is an explanatory view (sectional view) illustrating a growth vessel 12.

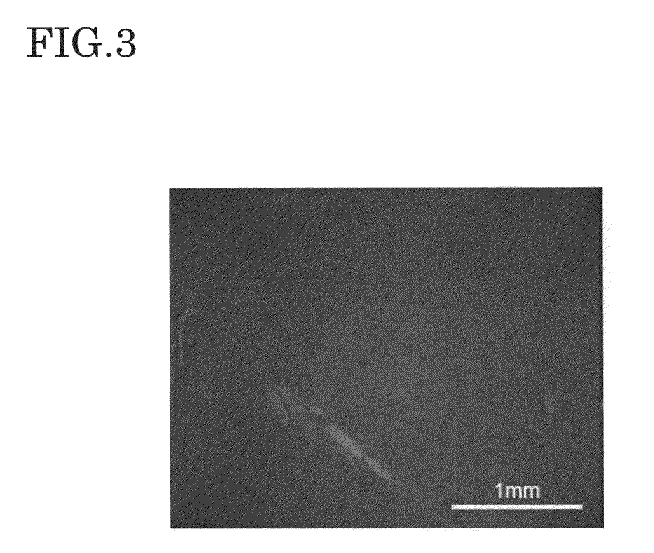

FIG. 3 is a photograph of a fluorescence microscopic image of a gallium nitride crystal in EXAMPLE 1.

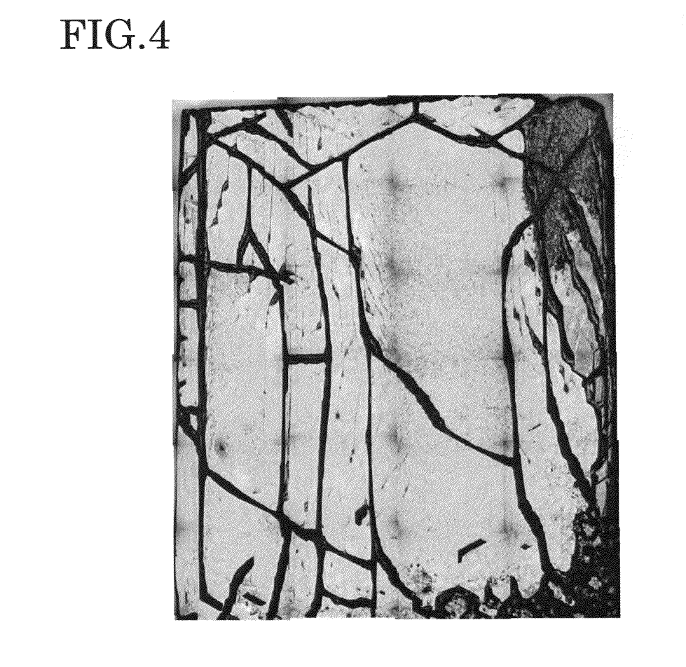

FIG. 4 is an exterior photograph of an etched gallium nitride crystal in EXAMPLE 1.

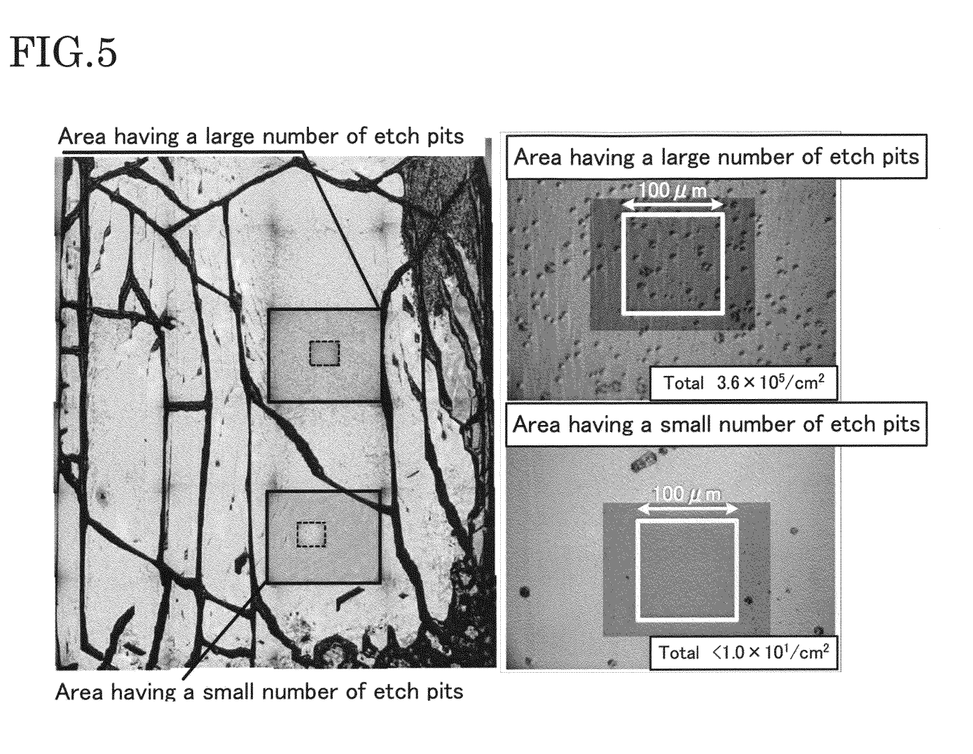

FIG. 5 illustrates photographs of magnified fields of view of an area having a large number of etch pits and an area having a small number of etch pits.

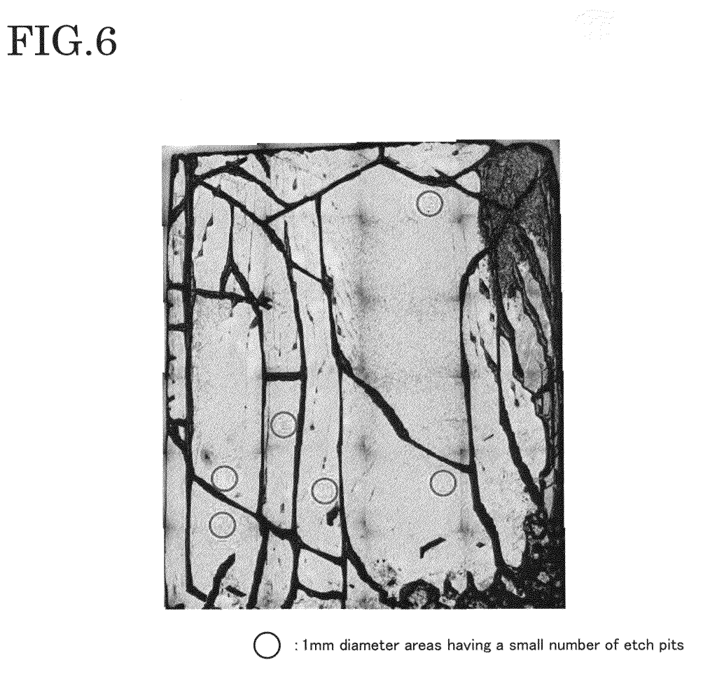

FIG. 6 is an exterior photograph of an etched gallium nitride crystal in EXAMPLE 1 where 1 mm diameter areas having a small number of etch pits are indicated with circles.

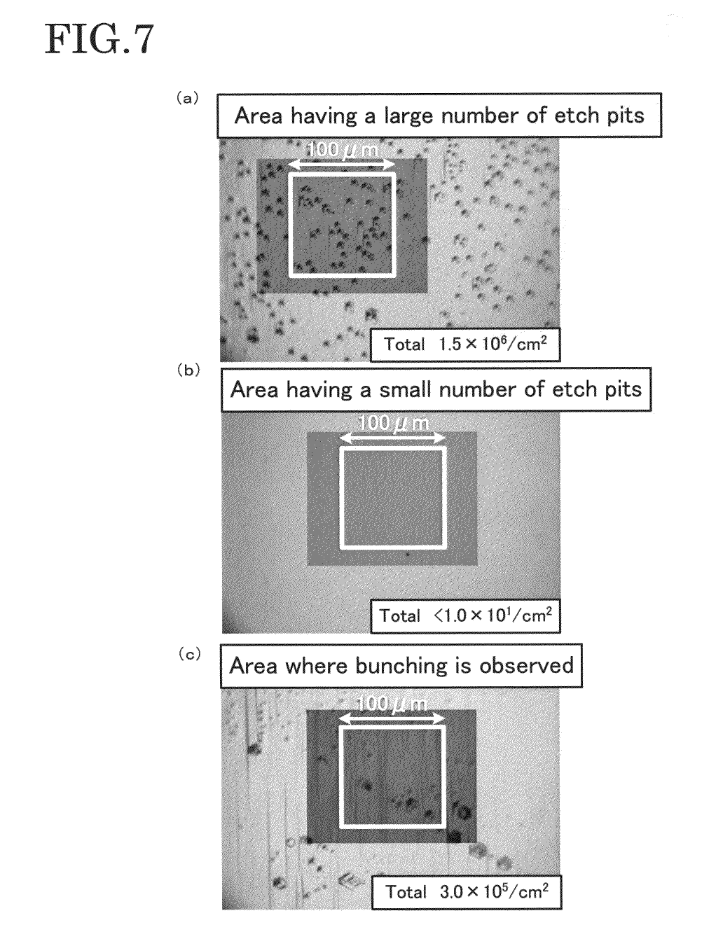

FIG. 7 illustrates photographs of magnified fields of view of an area having a large number of etch pits, an area having a small number of etch pits, and an area where bunching is observed in EXAMPLE 2.

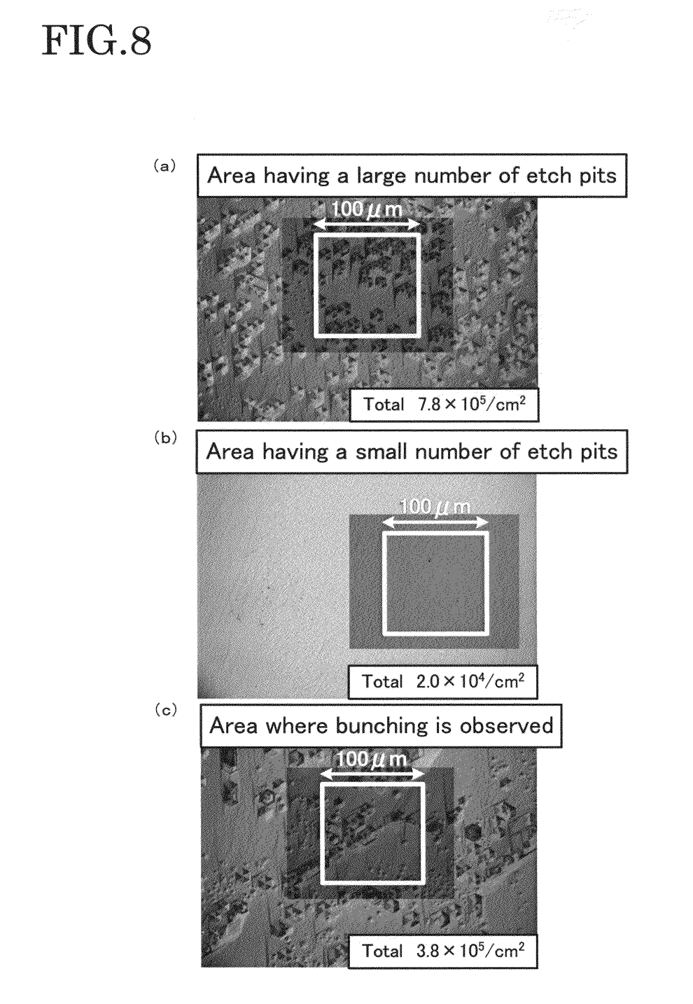

FIG. 8 illustrates photographs of magnified fields of view of an area having a large number of etch pits, an area having a small number of etch pits, and an area where bunching is observed in EXAMPLE 3.

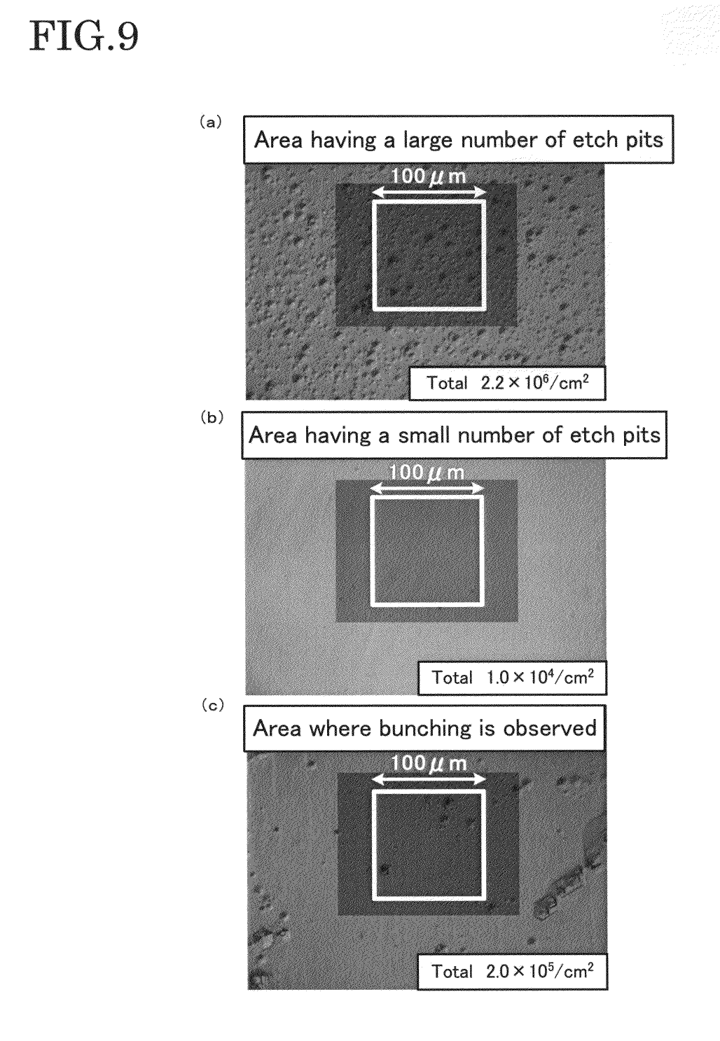

FIG. 9 illustrates photographs of magnified fields of view of an area having a large number of etch pits, an area having a small number of etch pits, and an area where bunching is observed in EXAMPLE 4.

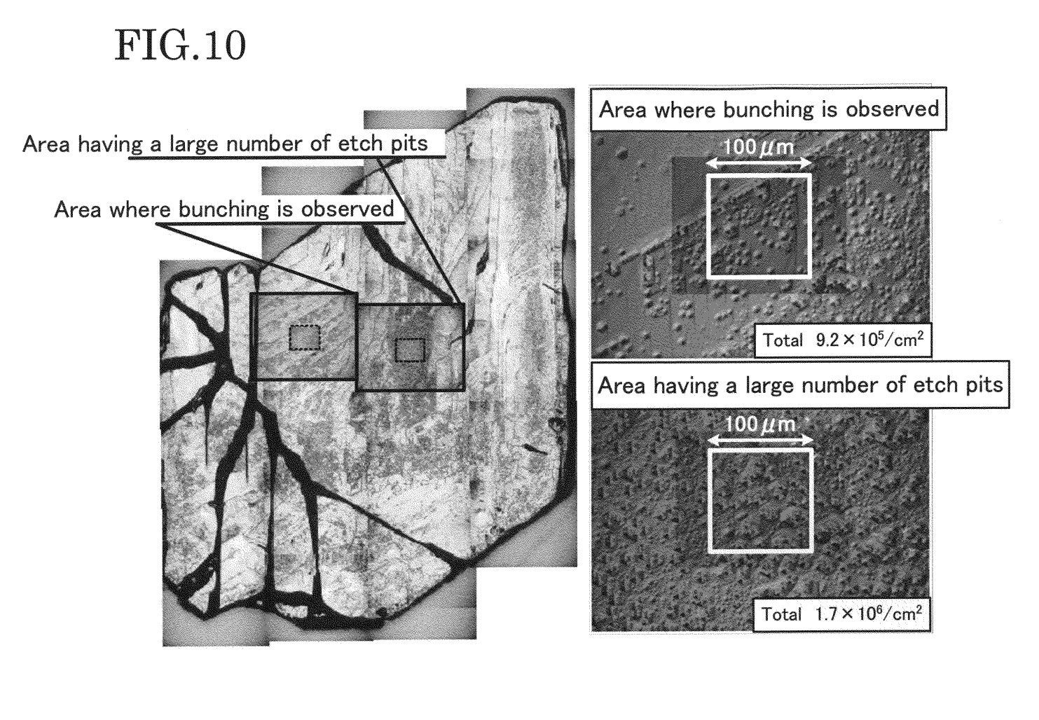

FIG. 10 illustrates photographs of magnified fields of view of an area where bunching is observed and an area having a large number of etch pits in COMPARATIVE EXAMPLE 1.

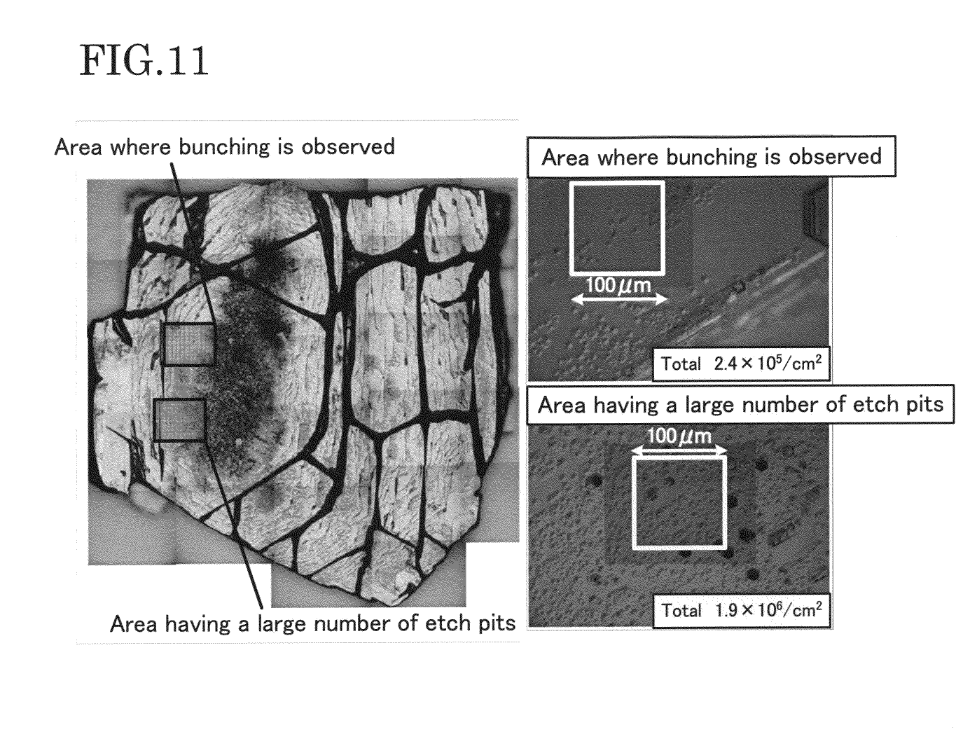

FIG. 11 illustrates photographs of magnified fields of view of an area where bunching is observed and an area having a large number of etch pits in COMPARATIVE EXAMPLE 2.

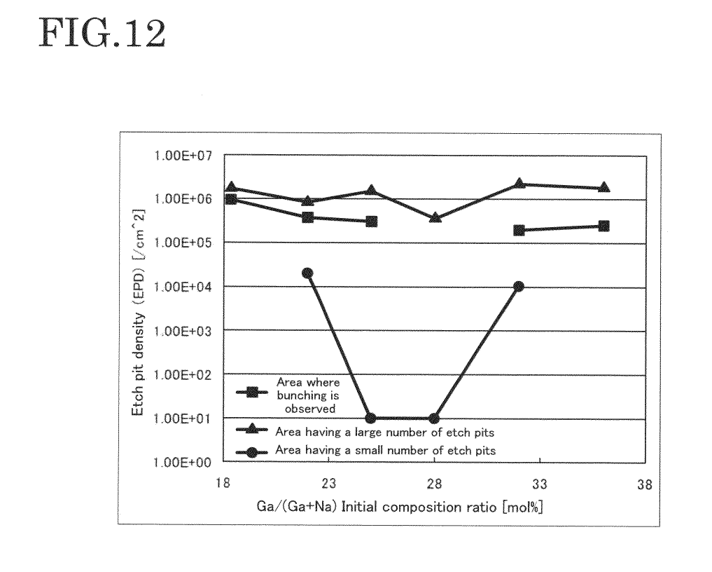

FIG. 12 illustrates a graph plotted with an ordinate axis indicating EPD in areas of EXAMPLES 1 to 4 and COMPARATIVE EXAMPLES 1 and 2 and an abscissa axis indicating the value of x.

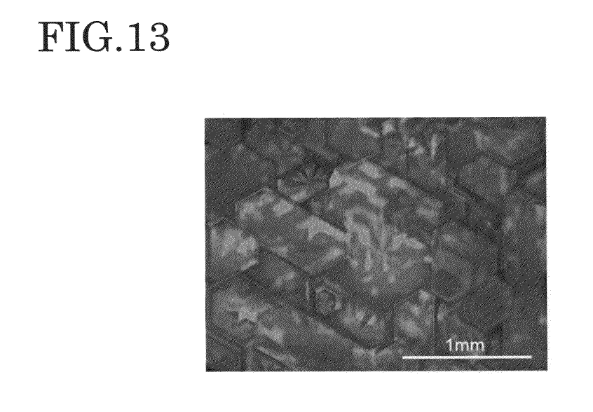

FIG. 13 is a photograph of a fluorescence microscopic image of a gallium nitride crystal grown under uniform-heating conditions without providing a temperature gradient in EXAMPLE 1.

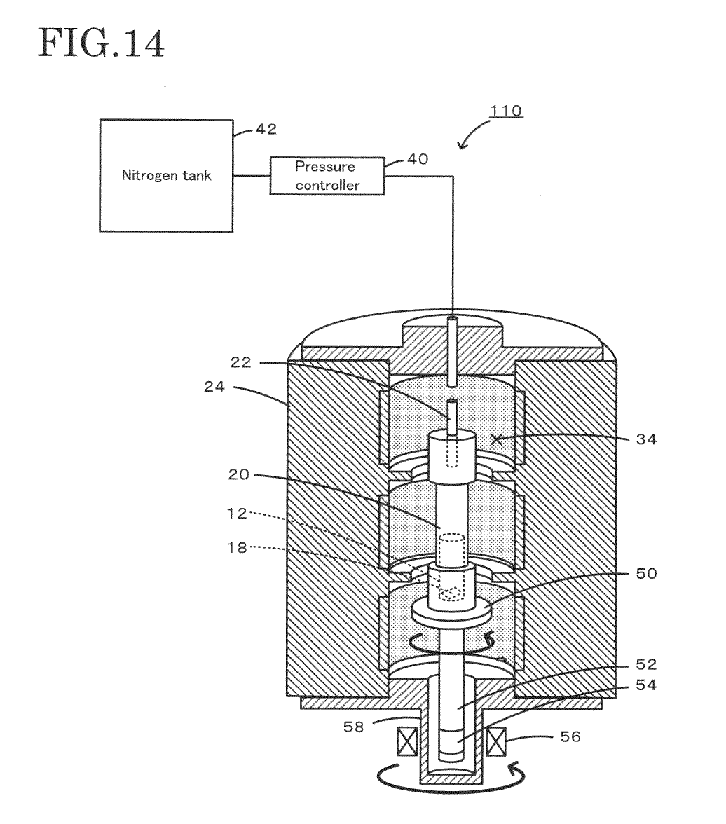

FIG. 14 is an explanatory view illustrating the entire configuration of a crystal substrate production apparatus 110.

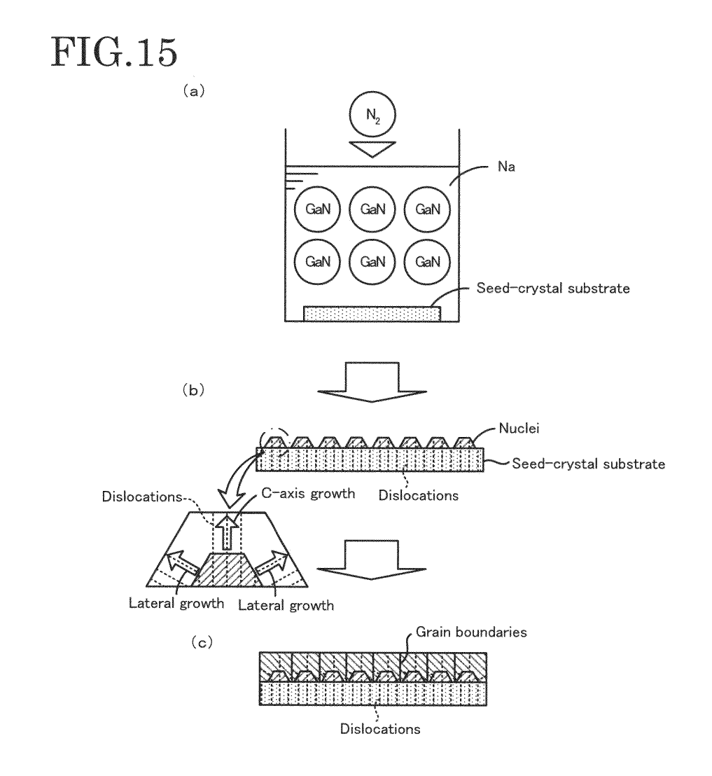

FIG. 15 is an explanatory view illustrating a crystal growth mechanism in the case where a Ga concentration is less than 22 mol %.

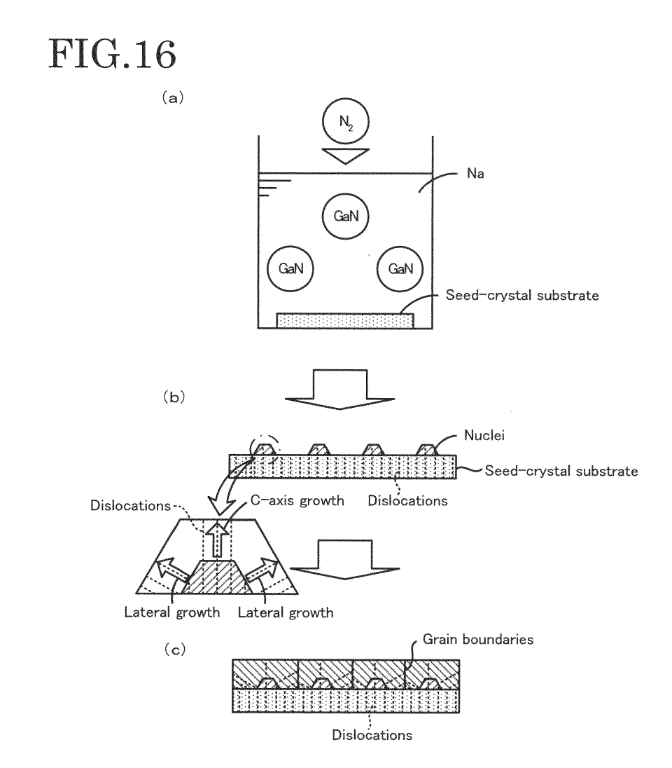

FIG. 16 is an explanatory view illustrating a crystal growth mechanism in the case where a Ga concentration is 22 to 32 mol %.

### DETAILED DESCRIPTION OF THE INVENTION

Hereinafter, a preferred apparatus for producing a group 13 nitride crystal according to the present invention will be described with FIGS. 1 and 2. FIG. 1 is an explanatory view illustrating the entire configuration of a crystal substrate production apparatus 10. FIG. 2 is an explanatory view (sectional view) illustrating a growth vessel 12.

As illustrated in FIG. 1, the crystal substrate production apparatus 10 includes the growth vessel 12; a reaction vessel 20 containing the growth vessel 12; an electric furnace 24 in which the reaction vessel 20 is placed; and a pressure controller 40 disposed at an intermediate point along a pipe connecting a nitrogen tank 42 and the reaction vessel 20 made of stainless steel.

The growth vessel 12 is an alumina crucible having the shape of a cylinder with a bottom. As illustrated in FIG. 2, in the growth vessel 12, a seed-crystal substrate 18 including a sapphire substrate 14 on a surface of which a thin film 16 of the group 13 nitride is formed is placed. The seed-crystal substrate 18 is placed such that the surface thereof is at an angle (that is, oblique) with respect to the horizontal direction. The growth vessel 12 contains a group 13 metal and a flux. The flux may be appropriately selected from various metals in accordance with the group 13 metal. For example, when the group 13 metal is gallium, alkali metals are preferred as the flux, more preferably sodium metal and potassium metal, still more preferably sodium metal. The group 13 metal and the flux are heated to be turned into a melt mixture.

The reaction vessel 20 is made of stainless steel. An inlet pipe 22 through which nitrogen gas can be introduced is inserted into an upper portion of the reaction vessel 20. The lower end of the inlet pipe 22 is in the reaction vessel 20 and in a space above the growth vessel 12. The upper end of the inlet pipe 22 is connected to the pressure controller 40.

The electric furnace 24 includes a hollow cylindrical body 26 within which the reaction vessel 20 is placed; and an upper lid 28 and a lower lid 30 for respectively closing the upper opening and lower opening of the cylindrical body 26. The electric furnace 24 is of a three-zone heater type and divided with two ring-shaped partition panels 32 and 33 disposed on the inner wall of the cylindrical body 26, into three zones: an upper zone 34, a middle zone 35, and a lower zone 36. An upper heater 44 is embedded in an internal wall surrounding the upper zone 34. A middle heater 45 is embedded in an internal wall surrounding the middle zone 35. A lower heater 46 is embedded in an internal wall surrounding the lower zone 36. The heaters 44, 45, and 46 are controlled with a heater controller (not shown) so as to have target temperatures individually set in advance. The reaction vessel 20 is contained such that the upper end thereof is in the upper zone 34 and the lower end thereof is in the lower zone 36.

The pressure controller 40 controls nitrogen gas fed to the reaction vessel 20 such that the pressure of the nitrogen gas is made to be a target pressure set in advance.

An example of using the crystal substrate production apparatus 10 having the above-described configuration according to the present embodiment will be described. The crystal substrate production apparatus 10 is used to produce a group 13 nitride by a flux method. Hereinafter, a case of producing a gallium nitride crystal substrate will be described as an example.

The seed-crystal substrate 18 is prepared that includes the sapphire substrate 14 on a surface of which the thin film 16 of gallium nitride is formed. The seed-crystal substrate 18 is placed in the growth vessel 12. At this time, the seed-crystal substrate 18 is supported at an angle with respect to the horizontal direction. Gallium metal is prepared as the group 13 metal and sodium metal is prepared as the flux. Gallium metal and sodium metal are weighed so as to achieve a desired molar ratio and added into the growth vessel 12. The growth vessel 12 is placed in the reaction vessel 20. The inlet pipe 22 is connected to the reaction vessel 20 and the reaction vessel 20 is filled with nitrogen gas from the nitrogen tank 42 through the pressure controller 40. The reaction vessel 20 is placed in the cylindrical body 26 of the electric furnace 24 so as to extend from the upper zone 34 through the middle zone 35 to the lower zone 36. The lower lid 30 and the upper lid 28 are closed. While the pressure controller 40 is used such that the inside of the reaction vessel 20 is at a predetermined nitrogen gas pressure and the upper heater 44, the middle heater 45, and the lower heater 46 are controlled with a heater controller (not shown) so as to individually have predetermined target temperatures, a gallium nitride crystal is grown. The pressure of the nitrogen gas is preferably set at 1 to 7 MPa, more preferably 2 to 6 MPa. The average temperature of the three heaters is preferably set at 700 to 1000° C., preferably at 800 to 900° C. The growth time of a gallium nitride crystal may be appropriately set in accordance with heating temperature or the pressure of pressurized nitrogen gas, for example, in the range of several hours to several hundred hours.

In the present embodiment, to generate heat convection in the melt mixture in the growth vessel 12, the target temperatures are set such that the temperature of the lower heater 46 is higher than those of the upper heater 44 and the middle heater 45. Due to the thus-generated heat convection, the melt mixture flows along the surface of the thin film 16 of the seed-crystal substrate 18 as represented by an arrow of an alternating long and short dashed line in FIG. 2. Specifically, the temperatures of the upper, middle, and lower heaters 44 to 46 are preferably set such that, in the melt mixture, the temperature of a lower portion is 1 to 8° C. higher than the temperature of an upper portion. When the difference is less than 1° C., heat convection is not sufficiently generated and the effect of increasing grain size is less likely to be provided, which is not preferable. When the difference is more than 8° C., the flux is transported along the inner wall of the growth vessel to an upper portion of the growth vessel having a lower temperature and hence the flux in the amount sufficient and necessary for the growth is less likely to be provided, which is not preferable. In addition, the degree of supersaturation at the gas-liquid interface becomes too high compared with the region where the seed-crystal substrate is placed and hence extraneous crystals tend to be generated at the gas-liquid interface and deposition of gallium nitride on the seed-crystal substrate is hampered, which is not preferable. In addition, since the temperature of the gas-liquid interface becomes lower than that of the growth region, the dissolution rate of nitrogen decreases and the growth rate decreases, which is not preferable.

According to the present embodiment having been described so far in detail, in the growth of a group 13 nitride crystal, while a flow along a surface of the seed-crystal substrate 18 is generated in the melt mixture, nitrogen gas is fed to the growth vessel 12 and hence the grain size tends to increase. Specifically, the group 13 nitride crystal can be made to have a grain size in which a circle having a diameter of 1 mm can be contained. In general, when such a melt mixture including a flow is used, the dislocation density tends to increase. However, by setting the concentration of the group 13 metal at 22 to 32 mol % in the melt mixture, the dislocation density can be reduced to a low value. Specifically, an etch pit density (EPD) in the circle having a diameter of 1 mm can be reduced to a value on the order of 10⁴/cm² or less. In addition, when the concentration is set at 25 to 30 mol %, in particular, 25 to 28 mol %, EPD can be reduced to a value on the order of 10¹/cm² or less or a state where no etch pit is observed can be achieved.

Since the melt mixture flows along a surface of the seed-crystal substrate 18 due to heat convection, the necessity of using an external power source such as a motor has been eliminated and the configuration of the production apparatus is simplified.

Since the seed-crystal substrate 18 is supported at an angle with respect to the horizontal direction, the melt mixture tends to flow along a surface of the seed-crystal substrate 18 due to heat convection and hence an appropriate flow rate is likely to be achieved. At this time, the seed-crystal substrate 18 may be preferably supported at 10 to 90°, more preferably 45 to 90°. In this case, the melt mixture can be made to have a high flow rate.

Since the partition panels 32 and 33 are disposed in the electric furnace 24, compared with the case without these partition panels, a temperature difference tends to be generated between an upper portion and a lower portion of the melt mixture in the growth vessel 12 contained in the reaction vessel 20 and the degree of generation of heat convection is readily controlled with the temperature difference between the upper, middle, and lower heaters 44 to 46.

Hereinafter, a mechanism by which a group 13 nitride crystal obtained in accordance with the present embodiment has a low dislocation density and a large grain size will be described with reference to FIGS. 15 and 16. Note that the mechanism below is a deduction drawn from the results of EXAMPLES and COMPARATIVE EXAMPLES described below. A case of using a melt mixture in which Ga, group 13 metal, is dissolved in sodium flux will be described as an example.

Firstly, comparison between a case where a Ga concentration is less than 22 mol % and a case where the Ga concentration is 22 to 32 mol % provides the following consideration. In the former case, since the amount of Ga in the flux is small, N₂ tends to dissolve in the flux and the concentration of GaN becomes high at the time of saturation (refer to FIG. 15(a)). As a result, the generation amount of nuclei that serve as starting points of crystal growth on the seed-crystal substrate increases (refer to FIG. 15(b)). In contrast, in the latter case, since the amount of Ga in the flux is large, N₂ is less likely to dissolve in the flux and the concentration of GaN becomes low at the time of saturation (refer to FIG. 16(a)). As a result, the generation amount of nuclei is probably small (refer to FIG. 16(b)). Since dislocations present in the seed-crystal substrate extend through nuclei in the longitudinal direction, a large generation amount of nuclei results in a large dislocation amount while a small generation amount of nuclei results in a small dislocation amount. Probably for these reasons, the dislocation density is high in the case where the Ga concentration is less than 22 mol % while the dislocation density is low in the case where the Ga concentration is 22 to 32 mol %.

Secondly, comparison between the case where the Ga concentration is less than 22 mol % and the case where the Ga concentration is 22 to 32 mol % provides the following consideration. In the former case, since the generation amount of nuclei is large, the distance between neighboring nuclei is probably small (refer to FIG. 15(b)). In contrast, in the latter case, the distance is probably large (refer to FIG. 16(b)). The nuclei probably have the shape of a prismoid and crystal growth includes growth in a direction perpendicular to the C face (C-axis growth) and growth in a direction perpendicular to side surfaces (lateral growth). In the former case, the width in which the lateral growth proceeds is small and hence the C-axis direction growth proceeds compared with the lateral growth. In the latter case, the width in which the lateral growth proceeds is large and hence the lateral growth is promoted. When the lateral growth is promoted, dislocations generated in neighboring nuclei meet and the meeting points serve as ends of grain size (that is, grain boundaries) and a large number of dislocations converge to the meeting points. Probably for these reasons, the dislocation density is high and the grain size is small in the case where the Ga concentration is less than 22 mol % (refer to FIG. 15(c)) while the dislocation density is low and the grain size is large in the case where the Ga concentration is 22 to 32 mol % (refer to FIG. 16(c)).

When the Ga concentration is more than 32 mol %, the dislocation density becomes high. This is probably caused by the following mechanism. When the Ga concentration is more than 32 mol %, the generation amount of nuclei is too small, the lateral growth dominantly proceeds, and the growth in the C-axis direction scarcely occurs. Thus, the crystal probably grows in the form of a bed of nails. At this time, since the concentration of GaN at the time of saturation is too low, neighboring grains are separated too far and dislocations generated in neighboring nuclei are less likely to meet. As a result, the width of grain boundaries increases and dislocations supposed to converge in the grain boundaries remain without converging. Probably by this mechanism, the dislocation density becomes high.

In the above-described embodiment, heat convection is used to generate a flow along a surface of the seed-crystal substrate 18 in the melt mixture. Alternatively, a flow along a surface of the seed-crystal substrate 18 may be generated in the melt mixture in the growth vessel 12 by disposing, in the electric furnace 24, a turntable that is equipped with a shaft and rotated by an external motor and by rotating the reaction vessel 20 containing the growth vessel 12 on the turntable. A specific example is illustrated in FIG. 14. A crystal substrate production apparatus 110 in FIG. 14 is the same as the crystal substrate production apparatus 10 except that the reaction vessel 20 is rotatable. Accordingly, only the difference of the crystal substrate production apparatus 110 from the crystal substrate production apparatus 10 will be described below. The reaction vessel 20 is placed on a disc-shaped turntable 50 to the bottom surface of which a rotational shaft 52 is secured. The rotational shaft 52 includes an internal magnet 54. The rotational shaft 52 rotates with rotation of a ring-shaped external magnet 56 that is disposed around a cylindrical casing 58, the rotation being achieved with an external motor (not shown). The inlet pipe 22 inserted into the reaction vessel 20 is cut off within the upper zone 34. Accordingly, as the rotational shaft 52 rotates, the reaction vessel 20 placed on the turntable 50 also rotates without being hampered. Nitrogen gas is fed from the nitrogen tank 42 through the pressure controller 40 to fill the electric furnace 24. The nitrogen gas is introduced through the inlet pipe 22 into the reaction vessel 22. Use of the crystal substrate production apparatus 110 allows generation of a flow along a surface of the seed-crystal substrate 18 in the melt mixture in the growth vessel 12. The orientation of the seed-crystal substrate in the growth vessel 12 is preferably determined such that a vortex flow generated in the melt mixture is parallel to a surface of the seed-crystal substrate 18.

### EXAMPLES

### Example 1

A gallium nitride crystal substrate was produced with the crystal substrate production apparatus 10 illustrated in FIG. 1. Hereinafter, the production procedures will be described in detail. In a glove box having an argon atmosphere, a 10 mm×15 mm seed-crystal substrate 18 was placed at 60° with respect to the horizontal direction in the growth vessel 12 so as to lean on a side wall of the growth vessel 12; and gallium metal and sodium metal were weighed so as to achieve a molar ratio of Ga:Na=x:(100−x) where x=28 and added into the growth vessel 12. The growth vessel 12 was put into the reaction vessel 20. While the cylindrical body 26 of the electric furnace 24 was purged with nitrogen gas, the reaction vessel 20 was put into the cylindrical body 26 and the cylindrical body 26 was sealed with the upper lid 28 and the lower lid 30. A gallium nitride crystal was then grown under predetermined growth conditions. In EXAMPLE 1, the growth was performed for 100 hours under conditions of a nitrogen pressure of 4.5 MPa and an average temperature of 875° C. The upper heater 44 and the middle heater 45 were set at 865° C. The lower heater 46 was set at 885° C. A temperature gradient (ΔT) from the upper end of the upper heater 44 to the lower end of the lower heater 46 was set at 20° C. At this time, the temperature difference in the melt mixture in the growth vessel 12 between the gas-liquid interface and a bottom portion in the growth vessel was about 5° C. By achieving the temperature gradient, heat convection was generated in the melt mixture in the growth vessel 12. As a result, the melt mixture flows upward along the surface of the thin film 16 of the seed-crystal substrate 18 as represented by an arrow of an alternating long and short dashed line in FIG. 2. After the reaction is completed, the temperature was allowed to decrease naturally to room temperature. The reaction vessel 20 was then opened and the growth vessel 12 was taken out therefrom. Ethanol was added into the growth vessel 12 to dissolve sodium metal in ethanol. The gallium nitride crystal substrate grown was then collected.

A photograph of a fluorescence microscopic image of the gallium nitride crystal in EXAMPLE 1 is illustrated in FIG. 3. In the photograph of the fluorescence microscopic image, fluorescence emitted by irradiation with ultraviolet rays having a wavelength of 330 to 385 nm is taken. In FIG. 3, which is displayed in a gray scale for convenience, grain boundaries can be identified with actually pale blue emission from impurity bands and grain size can be roughly determined. From FIG. 3, it has been confirmed that a gallium nitride crystal having a large grain size in which at least a circle having a diameter of 1 mm can be contained is obtained.

The surface (Ga surface) of the gallium nitride crystal in EXAMPLE 1 was lapped with the diamond slurry and etched by immersion into an acidic solution (a mixed solution of sulfuric acid:phosphoric acid=1:3 (volume ratio)) at 250° C. for about 2 hours. After the etching, differential-interference-image observation was performed with an optical microscope to observe etch pits derived from dislocations. An exterior photograph of the etched gallium nitride crystal is illustrated in FIG. 4. This exterior photograph was formed by combining several tens of images from the differential-interference-image observation of the etched gallium nitride crystal with an optical microscope. The irregular shape is caused by, for example, breaking of the crystal at cracked portions during cooling after growth and etching of lateral surfaces (surfaces perpendicular to the Ga surface) of the crystal. The black grooves are cracking having been enlarged by etching. The light blue portions (FIG. 4 is displayed in monochrome and hence gray portions) are portions with a small number of dislocations in which pits were not formed by etching and portions with no dislocations.

In addition, an etch pit density (EPD) was calculated in a magnified field of view covering a square of 100 μm per side. The magnified fields of view observed are illustrated in FIG. 5. Evaluation in terms of EPD was performed in the following manner. The differential-interference-image observation was performed to identity pits (etch pits) derived from dislocations by visual inspection. Specifically, classification into (1) an area seeming to have a large number of etch pits; (2) an area seeming to have a small number of etch pits; and (3) an area where bunching is observed, was performed and EPD was calculated in each area. The term “bunching” means a phenomenon in which variation occurs in growth rates of atomic steps on the surface of a crystal and, as a result, the density of the steps fluctuates to form a macroscopically observable step. EPD was determined by calculating the number of etch pits in each area having the shape of a square of 100 μm per side. Since the center of dislocations is likely to be etched deeply, etch pits have the shape of a hexagonal pyramid. Etch pits have a size in the range of several micrometers to several tens of micrometers. This is probably because dislocations have different sizes depending on the types thereof (probably, in descending order of size, screw dislocation, mixed dislocation, and edge dislocation). Thus, EPD in each area was defined as a value obtained by dividing the total number of various etch pits by the areal value. Areas where no etch pits were observed as in the area having a small number of etch pits in EXAMPLE 1 were evaluated as EPD<10¹/cm² for convenience. In EXAMPLE 1, the (3) area where bunching is observed was not observed.

In view of the results in terms of EPD, 1 mm diameter areas having a small number of etch pits are illustrated in FIG. 6. In FIG. 6, 1 mm diameter areas having a small number of etch pits (areas where EPD was on the order of 10⁴/cm² or less) in the exterior photograph in FIG. 4 are indicated with circles. Accordingly, it has been demonstrated that the gallium nitride crystal substrate obtained in EXAMPLE 1 has a grain size in which a circle having a diameter of 1 mm can be contained and EPD within the circle is on the order of 10⁴/cm² or less.

### Examples 2 to 4

In EXAMPLES 2 to 4, gallium nitride crystal substrates were produced as in EXAMPLE 1 except that gallium metal and sodium metal were weighed such that x in EXAMPLE 1 was respectively changed to 22, 25, and 32. As in EXAMPLE 1, these substrates were also subjected to differential-interference-image observation, identification of etch pits by visual inspection, and determination of EPD in the areas (1) to (3). The results in EXAMPLES 2 to 4 are respectively illustrated in FIGS. 7 to 9.

### Comparative Examples 1 and 2

In COMPARATIVE EXAMPLES 1 and 2, gallium nitride crystal substrates were produced as in EXAMPLE 1 except that gallium metal and sodium metal were weighed such that x in EXAMPLE 1 was respectively changed to 18 and 36. As in EXAMPLE 1, these substrates were also subjected to differential-interference-image observation, identification of etch pits by visual inspection, and determination of EPD in the areas (1) to (3). The results in COMPARATIVE EXAMPLES 1 and 2 are respectively illustrated in FIGS. 10 and 11.

(Evaluation)

FIG. 12 illustrates a graph plotted with an ordinate axis indicating EPD in the areas of EXAMPLES 1 to 4 and COMPARATIVE EXAMPLES 1 and 2 and an abscissa axis indicating the value of x. From FIG. 12, there are areas where EPD within 1 mm diameter circles is on the order of 10⁴/cm² or less in EXAMPLES 1 to 4 (that is, x=22 to 32), whereas there are no such areas in COMPARATIVE EXAMPLES 1 and 2 (that is, x=18 and 36). In EXAMPLES 1 to 4 and COMPARATIVE EXAMPLES 1 and 2 (that is, x=18 to 36), grains have a size in which a 1 mm diameter circle can be contained and there is a tendency that the grain size increases with x. In contrast, when growth is performed under uniform-heating conditions without providing the temperature gradient (ΔT) in EXAMPLE 1, as illustrated in a fluorescence microscopic image in FIG. 13, grains have a size in which a circle having a diameter of 0.2 to 0.3 mm can be contained. As is clear from FIG. 13, when growth is performed under uniform-heating conditions, high emission from impurity bands due to grain boundaries was observed and grain size was small.

The present application claims the benefit of the priority from Japanese Patent Application No. 2009-012963 filed on Jan. 23, 2009, the entire contents of which are incorporated herein by reference.

### INDUSTRIAL APPLICABILITY

The present invention is applicable to high-frequency devices represented by power amplifiers and semiconductor devices such as blue LEDs, white LEDs, and violet semiconductor lasers.

1. A group 13 nitride crystal having a grain size in which a circle having a diameter of 1 mm can be contained,
herein an etch pit density within the circle is on the order of 10⁴/cm² or less.

2. The group 13 nitride crystal according to claim 1,
wherein the etch pit density within the circle is on the order of 10¹/cm² or less.

3. The group 13 nitride crystal according to claim 1,
wherein no etch pit is observed within the circle.

4. The group 13 nitride crystal according to claim 1,
wherein the group 13 nitride is gallium nitride.

5. The group 13 nitride crystal according to claim 4,
wherein the group 13 nitride crystal emits pale blue fluorescence by irradiation with light having a wavelength of 330 to 385 nm.

6. The group 13 nitride crystal according claim 2
wherein the group 13 nitride is gallium nitride.

7. The group 13 nitride crystal according claim 3
wherein the group 13 nitride is gallium nitride.
